(19) United States
(12) Patent Application Publication
(10) Pub. No.: US 2005/0058759 A1
(43) Pub. Date: Mar. 17, 2005

(54) Protein enhanced low carbohydrate snack food

(76) Inventor: James Carl Schmidt, Grosse Pointe Park, MI (US)

Correspondence Address: RADER, FISHMAN & GARAUER PLLC, 10653 SOUTH RIVER FRONT PARKWAY, SUITE 150, SOUTH JORDAN, UT, 84095, US

(21) Appl. No.: 10/919,986

(22) Filed: Aug. 17, 2004

Related U.S. Application Data
(60) Provisional application No. 60/502,990, filed on Sep. 15, 2003.

(51) Int. Cl. A23L 1/30

(52) U.S. Cl. 426/549

(57) ABSTRACT

A protein enhanced, low carbohydrate snack food having from about 10% to about 50% fat material, from about 5% to about 40% sugar substitute, from about 5% to about 50% protein material, and methods of making and using the same.

The present application claims priority under 35 U.S.C. § 119(e) from the following previously-filed Provisional Patent Application: U.S. Application No. 60/502,990, filed Sep. 15, 2003, entitled “Protein-Enhanced Low-Carbohydrate Dough for Cookies and Other Food Products,” filed by James C. Schmidt, and which is incorporated herein by reference in its entirety.

### FIELD OF THE INVENTION

The present invention relates to snack foods. More particularly, the present invention relates to protein enhanced, low carbohydrate snack foods, and methods for making and using the same.

### BACKGROUND

The current candy and confection industry is based upon refined sugar, high-fructose corn syrups and other sweeteners that cause excessive elevation of blood sugar when eaten. The excessive blood sugar not used by the body is converted to fat as an energy source for later use. High blood sugar resulting from eating sugar-carbohydrate rich candies and confections is believed to promote obesity and diabetes.

There has been a trend lately to use foods low in carbohydrates, especially those high in protein, as part of a diet advocated for many years by diet guru Robert Atkins, M.D., and often called the Atkins diet. After decades of medical ridicule, the Atkins diet recently gained some credibility with the release of widely publicized research from Duke University. Dieters in the Atkins-funded study lost an average of 20 pounds in six months, and also saw improvements in cholesterol and other cardiovascular risk factors.

Low carbohydrate diets, such as the Atkins diet, cause the body to burn fat and muscle tissue to obtain needed energy because there are no carbohydrates to supply the energy. To prevent losses of muscle tissue a dieter should also consume greater amounts of protein, since protein supplies energy and builds and repairs muscle tissue.

Most cookies contain high amounts of refined sugar, flour and other carbohydrate rich starches. Those cookies that are low in carbohydrates typically are not high in protein. Many traditional low carbohydrate cookies typically do not have a flavor that is favorable to a dieter's taste, and adding protein to such cookies makes it harder to create a favorable flavor.

Conventional efforts to make a protein enhanced, low carbohydrate cookie have also failed because previous cookies were unable to maintain proteins in a stable suspension. The proteins could not remain in a suspension because their natural density and inherent isoelectric pH caused them to resist suspension and/or to resist bonding in the presence of one or more different proteins. The proteins' isoelectric pH also caused them to repel each other rather than bond together.

Thus, it has been difficult to make a protein enhanced, low carbohydrate cookie for use in a low carbohydrate diet, such as the Atkins diet. The result is that it is more difficult for an individual to follow the diet and obtain the benefits therefrom.

### SUMMARY

A protein enhanced, low carbohydrate snack food has from about 10% to about 50% fat material, from about 5% to about 40% sugar substitute, from about 5% to about 50% protein material, up to about 50% bulking agent, and up to about 25% flavoring; and methods of making and using the same

### BRIEF DESCRIPTION OF THE DRAWING

The products and processes described herein can be understood in light of FIG. 1, which depicts one aspect of a method for making a protein enhanced, low carbohydrate snack food.

FIG. 1 illustrates a specific aspect of the products and processes described in the present specification and constitutes a part of the specification. Together with the following description, the FIGURE demonstrates and explains the principles of the products and processes.

### DETAILED DESCRIPTION

The following description provides specific details of embodiments of the invention. The skilled artisan will understand, however, that embodiments of the invention can be practiced without employing these specific details. Indeed, embodiments of the invention can be practiced by modifying the illustrated method and resulting product and can be used in conjunction with apparatus and techniques conventionally used in the industry. Embodiments of the invention, however, could easily be adapted for other uses. For example, other ingredients could be added to the snack food to provide additional benefits, or to make the snack food for a specific diet other than the Atkins diet. Additionally, the principles herein described could be used to create snack foods other than cookies.

The protein enhanced, low carbohydrate snack foods and cookies described herein deliver superior taste and texture that duplicate the gustatory pleasure of eating a typical carbohydrate-rich cookie, but without all the sugar and flour. Rather than relying only on flour or reduced carbohydrate flours, the cookie is made from plant and animal based proteins that are combined to form unique bonds and emulsions that have many of the characteristics of a traditional cookie dough. The cookie may be manufactured on the same equipment and processing of a typical modem cookie plant. The cookie may be used or eaten alone, or may be incorporated into snack foods such as ice cream sandwiches, layered and filled cookies or as ingredients in the manufacturing of other products. Indeed, this cookie may be used anywhere a conventional sugar-rich or sugar-free cookie may be used.

As used herein, “total carbohydrate content” refers to the sum total of all carbohydrates in the food. “Net effective carbohydrates” refers generally to those carbohydrates that have a significant impact on increasing blood glucose levels. While all concentrations used in this specification and in the appended claims are given in terms of weight percent of the cookie dough, the principles described herein apply to both the cookie and cookie dough, since the particular ingredients described as being used in the cookie are necessarily included in the cookie dough, unless otherwise indicated. Furthermore, all ingredients have the same functions and effects in the cookie as they do in the cookie dough. Finally, as used herein, the verbs “combine,” “add,” “mix” and “blend,” and any other similar terms, are used interchangeably in their ordinary meanings to refer to the action(s) of combining two or more components into one mass.

The present specification describes a protein enhanced, low carbohydrate cookie dough and cookie, snack foods comprising the cookie, and methods of making the cookie, cookie dough and snack foods. The cookie is made by baking a cookie dough, which generally contains fat material, a sugar substitute, protein material, flavorings and other ingredients as needed or desired.

The fat material used in the cookie affects the richness, flavor, texture and stability of the cookie, as well as hardness and melting properties. The fat material of the cookie can include vegetable fats and oils such as butter, cocoa butter, cream butter, salted butter, illippe butter, shea butter, margarine, vegetable shortening, sal oil, canola oil, palm oil, palm nuclei oil, cottonseed oil, sunflower seed oil, peanut oil, rice bran oil, corn oil, safflower oil, olive oil, kapok oil, sesame oil, almond oil, hazelnut oil, chili oil, coconut oil, grapeseed oil, mustard oil, soybean oil, trans fatty acids, walnut oil and evening primrose oil, and animal fats and oils such as cream, tallow, lard, fish oil, and whale oil. Generally, the fat material comprises from about 10% up to about 50% of the cookie. Preferably, the fat material comprises from about 18% to about 40%, and more preferably from about 25% to about 38% of the cookie.

Traditional cookies are made with natural sugar sweeteners, such as white sugar and brown sugar, and are thus high in total carbohydrate content. The protein enhanced, low carbohydrate cookie described herein, however, delivers a sweet taste while having a low net effective carbohydrate content because it replaces natural sugar sweeteners with sugar substitutes. Sugar substitutes do not significantly increase blood sugar levels and therefore do not count as net effective carbohydrates. The sugar substitutes used in the cookie may include sugar alcohols, high intensity sweeteners, fiber sweeteners or combinations thereof.

Sugar alcohols are well-suited for use as sugar substitutes in low carbohydrate foods. They can be up to about 95% as sweet as sucrose, and provide similar bulking properties as sucrose. Sugar alcohols are low-digestible carbohydrates because they are not fully absorbed from the intestines; thus, they provide fewer calories than sucrose and are less available for energy metabolism. Because of these properties, sugar alcohols do not cause the detrimental effects on diabetics that other carbohydrates cause. Examples of suitable sugar alcohols include, but are not limited to, mannitol, sorbitol, xylitol, lactitol, isomalt, maltitol, erythritol, D-tagatose, trehalose, isomalt and hydrogenated starch hydrolysates (HSH).

The total amount of sugar alcohol used in the cookie varies depending on the desired texture, consistency, taste and/or sweetness of the cookie, but generally comprises from about 5% up to about 40% of the cookie. Preferably, the sugar alcohol comprises from about 8% to about 36% of the cookie, and more preferably from about 15% to about 24%. In one aspect the sugar alcohol used in the cookie comprises crystalline maltitol. Additionally, maltitol solution and other sugar alcohol solutions may be used to improve the texture, moisture content and crystallization properties of the cookie. In another aspect the sugar alcohol is isomalt, a sugar substitute produced by the isomerisation and catalytic hydrogenation of sucrose, with subsequent solidification and milling. Since it is based on sucrose, isomalt can be substituted for natural sugar or any other sugar alcohol in a 1:1 mass ratio. In one aspect isomalt comprises up to about 12% of the cookie.

Other sugar substitutes that can also be used in the cookie include fiber sweeteners such as inulin and oligofructose. Inulin and oligofructose provide sweetness to the cookie, as well as add bulk and creaminess. Inulin and oligofructose are thus useful as fat replacements, are good sources of soluble dietary fiber and are well-suited for diabetics because they do not increase the blood sugar level or insulin level due to their indigestible nature. The amount of inulin or oligofructose can vary according to the desired color, flavor and texture of the cookie. Generally the fiber sweeteners can be used in addition to, or in place of, sugar alcohols. In one embodiment, the sugar substitute comprises inulin instead of sugar alcohols in order to further reduce or eliminate net effective carbohydrates. In another embodiment gums, such as guar gum, gum arabic, xanthan gum, carrageenan and pectin, can be added with the inulin to help improve the texture and to minimize or neutralize carbohydrates.

High intensity sweeteners can also be used in the cookie as sugar substitutes to reduce the net effective carbohydrate content of food while still providing a sweet taste. These high intensity sweeteners can be used in addition to, or in place of, sugar alcohols and fiber sweeteners. These sweeteners can be hundreds of times sweeter than sucrose, yet they contain many fewer calories than sucrose. High intensity sweeteners also have little to no effect on blood sugar levels. High intensity sweeteners include, but are not limited to, aspartame, alitame, neotame, cyclamates, saccharin, acesulfame, sucralose, neohesperidin dihydrochalcone, stevia sweeteners, glycyrrhizin, thaumatin, and the like, and mixtures thereof. Usually the amount of high intensity sweetener used in the cookie is scant since it has such an intense sweetness. In one aspect the high intensity sweetener comprises less than 1% of the cookie. Nevertheless, the concentration of the high intensity sweetener will depend upon its sweetness and the desired sweetness of the cookie.

The cookie also comprises protein material in order to provide additional nutritional benefits and an alternative from the traditional method for supplying protein in a diet. The protein material that can be used in the cookie includes, but is not limited to, soy and soy isolates, whey and whey isolates, micro cross filtered whey isolates, wheat proteins (e.g., glutenir, gliadin, and gluten), isolated grain and vegetable proteins, egg white protein, protein isolates, and albumen isolates. Vegetable proteins include any vegetable in which proteins may be collected, whether condensed, accumulated or isolated. Examples of protein-providing vegetables include spelt, quinoa, amaranth, buckwheat, black rice and the like.

Generally, the protein material can comprise from about 5% up to about 50% of the cookie. Preferably, the protein material comprises from about 7% to about 38%, and more preferably from about 12% to about 30%. The protein material can be any single type of protein, or may be a blend of various proteins that provides unique texture, flavor, durability and strength characteristics to the cookie based on the composition of the blend.

Whey protein is available in a number of different types based upon the protein content of the whey source. The different whey sources that can be used in the cookie include, but are not limited to, whey protein concentrate, whey protein isolate, micro cross filtered whey protein isolate and hydrolyzed whey protein. Whey proteins assist in maintaining the consistency of the cookie, i.e. they help “glue” the cookie together and keep it cohesive. Generally, the cookie dough contains from about 2% up to about 20% whey protein. Preferably, the cookie dough contains from about 2% to about 15%, and more preferably from about 2% to about 13% whey protein.

The cookie can also comprise wheat proteins, such as gluten. In addition to providing nutritional benefits as a protein, wheat protein affects the texture and consistency of the cookie by making it “snappy” and crunchy. In one aspect the wheat protein is added in the form of gluten powder. Generally, the cookie contains from about 4% up to about 20% wheat protein. Preferably, the cookie contains from about 4% to about 15% wheat protein, and more preferably from about 6% to about 14% wheat protein.

The cookie can also contain soy protein. Soy proteins function to replace non-fat dry milk when combined and baked with other ingredients, such as whey. Soy protein also functions to impart a granular texture and consistency to the cookie, increasing the cookie's ability to dissolve and crumble. Soy protein is available in soy flours, soy protein concentrates, and soy protein isolates. Generally, soy protein is added to the cookie as a component of a protein blend. The amount of soy protein in a particular protein blend is determined by the functional and/or nutritional requirements of the cookie product. In one aspect, the cookie comprises soy protein in a concentration of up to about 15%. Preferably, soy protein comprises up to about 11% of the cookie dough, and more preferably from about 2% up to about 11%.

The cookie can also contain caseins, such as calcium caseinate or sodium caseinate. Caseins are good sources of protein for nutrition, but they also perform other functions when used in foods. For example, they are good emulsifiers, helping fats to stay suspended in water based products. They are also used as binders, and can be used to cause fine particles to coagulate with the protein so they can be easily filtered out or precipitated. In one aspect of the cookie, calcium caseinate is added to help set up the dough for protein bonding.

The cookie may also contain bulking agents to give bulk and body to the cookie. The concentration of bulking agent used in the cookie generally ranges up to about 50% of the cookie. Preferably, the concentration ranges up to about 40%, and more preferably up to about 30%. Nevertheless, the amount of bulking agent depends on the desired consistency and mouth feel of the cookie, and may be altered in any manner to achieve the desired results. Furthermore, the cookie may also contain a combination or mixture of two or more bulking agents.

Suitable bulking agents for use in the cookie include starch, starch hydrolysates, hydrogenated starch hydrolysates and polydextrose. Examples of suitable starches include starch obtained from corn, potato, wheat and rice. Examples of suitable starch hydrolysates include maltodextrins and especially low DE maltodextrins. The maltodextrin can be from any source of starch to corn, wheat, potato, and rice. Because starches are so good at absorbing water and bulking up, they are important in the “mouth feel” of many food products, and are used as fat substitutes. Starches also help hold the shape of the food material, especially in snack-like products. In one aspect starch is provided by flour, which can be bleached or unbleached. Generally, flour comprises up to about 40% of the cookie. In one aspect flour comprises from about 10% to about 30% of the cookie, and in another aspect comprises from about 14% to about 27%. Sugar alcohols and protein material can also give bulk and body to the cookie.

Fiber may also be used in addition to, or in place of, flour and starch bulking agents and protein material. Fiber gives good mouth feel and helps provide flavor balance to an otherwise protein-dominated cookie. The fiber that may be used in the cookie includes plant-based fibers, such as those derived from vegetables, legumes, fruits and grains. The fiber may be soluble or insoluble, and includes, but is not limited to, non-starch polysaccharides, resistant starches, modified starches, lignin and fructo-oligosaccharides. Although fructo-oligosaccharides are not technically fibers, they are classified as dietary fiber since they are not absorbed in the intestine, and therefore have a zero net carbohydrate effect. Examples of suitable fructo-oligosaccharide fiber include inulin and oligofructose. Generally, fiber can comprise up to about 40% of the cookie. Preferably, fiber comprises from about 7% up to about 37%, and more preferably from about 10% up to about 20%. In one aspect fiber comprises about 11% of the cookie.

When used in place of protein, fiber can generally replace up to about 75% of whey protein, up to about 75% of soy protein and up to about 50% of wheat protein, in a 1:1 mass ratio. Furthermore, by using fiber, such as bamboo fiber, in place of flour and starch allows the net effective carbohydrate content to be reduced. Thus, a zero net carbohydrate cookie can be made in accordance with the principles and ingredients discussed above. Including fiber in the cookie also provides beneficial results in that fiber tends to be rich in antioxidants and low in fat and calories. A fiber rich diet is also beneficial in alleviating and preventing conditions including constipation, diverticulosis, colon and rectal cancer, heart disease, breast cancer, diabetes and obesity.

The cookie may be used in a variety of different applications, and thus may be of any flavor. Typically flavor is imparted to the cookie by the addition of flavoring. The concentration of flavoring can be adjusted according to need and to taste. Examples of flavors and flavorings (hereinafter “flavorings”) that can be used in the cookie include, but are not limited to, mint, peppermint, cinnamon, vanilla, fruit, fruit extracts and essences, nut extracts, chili pepper, chocolate, caramel, peanut butter, sarsaparilla, salt, sassafras, wild cherry, wintergreen, ginger, nutmeg, pumpkin, oatmeal, honey, malt, grain flavors, paprika, garlic, and combinations thereof. The chocolate flavoring may include any product that imparts a chocolate flavor, including, but not limited to, cocoa butter, chocolate liquor, natural cocoa, jet black cocoa, Dutch cocoa and artificial chocolate flavoring.

The cookie may also contain various other components as needed and as desired. For example, the cookie may contain eggs, which provide another good source of protein for the cookie. The eggs can be whole eggs or powdered whole eggs rehydrated with water. The whole or rehydrated eggs generally comprise from about 5% up to about 20% of the cookie. Preferably the eggs comprise from about 5% to about 15% of the cookie, and more preferably from about 10% to about 13%.

Water can also be added to the cookie dough, but all, or nearly all, is either absorbed by the protein material or evaporated during baking. Nevertheless, adding water to the cookie dough increases the moisture of the cookies and provides an environment for the other cookie dough ingredients to interact. For example, the water provides a medium for the proteins to form into a bonded suspension with each other. The amount of water added to the cookie dough depends largely on the type of eggs used and the amount of protein material added. Soy protein absorbs much more water than does whey protein, and thus requires the addition of greater amounts of water. Generally, water the cookie comprises up to about 14% water. Preferably, the cookie comprises up to about 11% water, and more preferably from about 4% to about 11% water.

The cookie may also contain other components that improve the overall quality of the cookie. For example, to improve eye appeal the cookie may contain colorants, including natural and artificial dyes, pigments, and compounds containing such. Colorants include beta carotene, turmeric, saffron, erioglaucine, indigotine, fast green, erythrosin B, allura red, tartrazine, sunset yellow, annatto, lycopene, carmine, indigo, titanium dioxide, zinc oxide, ferrous gluconate, caseins, caramel color, egg shade color, cocoa jet black, natural cocoa, and other colorants known to those of skill in the art.

The cookie may also contain an emulsifier. Suitable emulsifiers include, but are not limited to, lecithin, sorbitan monostearate, polysorbate 80, glycerol monostearate, tetrasodium pyrophosphate and sodium stearoyl lactylate. The cookie may also contain a leavening agent to lighten the cookie, such as yeast, baking powder, baking soda, ammonium bicarbonate and ammonium carbonate. Baking soda may also be added to neutralize acidic components in the cookie, such as natural cocoa.

Finally, the cookie may contain other non-reactive and non-soluble flavor pieces to add flavor, eye appeal, and to make the cookie more desirable. Examples of these flavor pieces include chocolate chips, butterscotch chips, peanut butter chips, vanilla baking chips, cinnamon baking chips, nuts, almonds, peanuts, walnuts, pecans, macadamia nuts, pistachios, chocolate chunks, dried fruits, raisins, coconut, marshmallows, rolled oats, chocolate candies, crispy rice cereal, toffee, sunflower, sprouts, flaxseed, flax, corn flakes, frikeh, wheat flakes, rice spelt, kamut, quinoa, white sesame, soybeans, barley, millet, oats, rye and triticale.

The cookie can also act as an ideal carrier for vitamins and minerals. Examples of vitamins that can be added to the cookie include, but are not limited to, vitamin A, vitamin B₁₂, vitamin C, vitamin D, vitamin E, vitamin K, para-aminobenzoic acid, Vitamin B₂ (riboflavin), Vitamin B₆, niacin, inositol, biotin, folic acid, choline, and vitamin B₁. Examples of minerals that can be added include, but are not limited to, magnesium, iron, zinc, copper, manganese, sodium, potassium, calcium, selenium, chromium, molybdenum, chlorine, fluorine, phosphorus, sulfur, and iodine. The cookie can also contain botanicals (neutraceuticals) including, but not limited to, bilberry, cascara, cat's claw, cayenne, cranberry, devil's claw, dong quai, echinacea, evening primrose oil, feverfew, garlic, ginger, ginkgo, Asian ginseng, Siberian ginseng, goldenseal, gotu kola, grape seed, green tea, hawthorn, kava, licorice, milk thistle, noni, saw palmetto, St. John's wort, valerian, melatonin, damiana, yerbe mate, guarana, and the like.

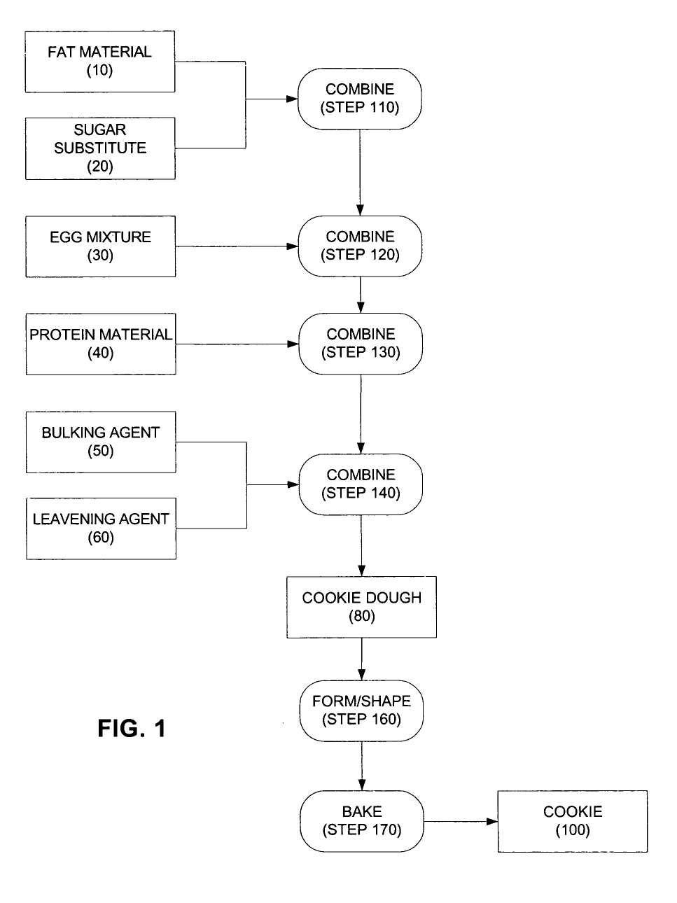

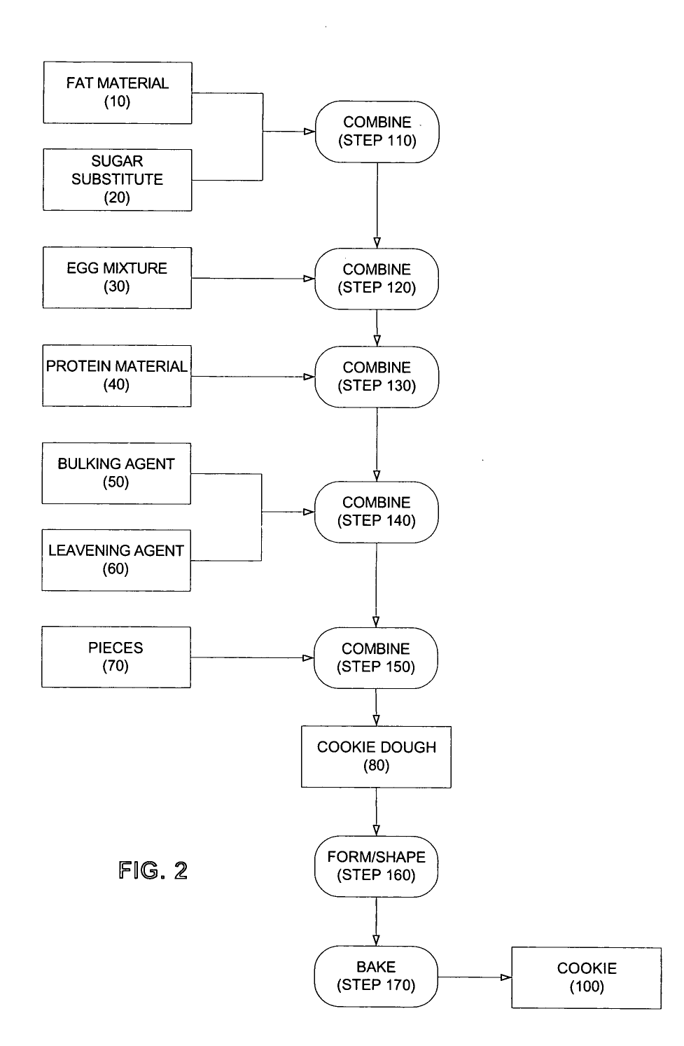

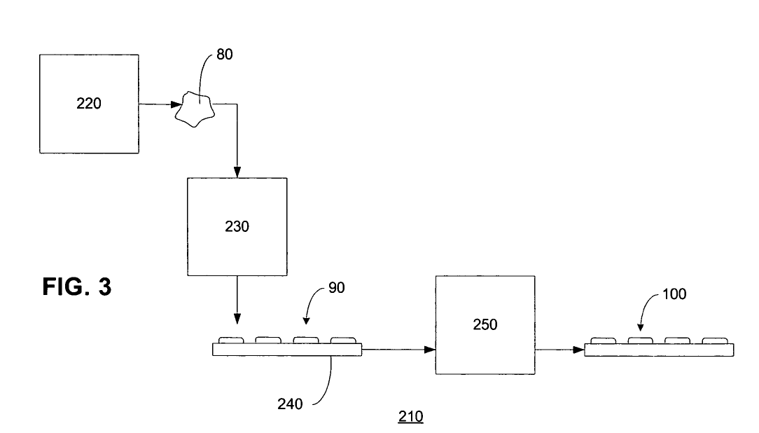

As shown in FIG. 1, the cookie is prepared according to a general sequence of adding and blending the above-described ingredients. First, fat material (10) and a sugar substitute (20) are combined (step 110) until the mixture becomes smooth. Generally, the sugar substitute (20) comprises sugar alcohol(s), but in one embodiment the sugar substitute (20) comprises inulin instead of sugar alcohols. In this embodiment, the sugar substitue (20) is prepared by rehydrating dried inulin with water at about 140° F. into an inulin solution and allowing the solution to simmer to remove excess water. The inulin solution, as the sugar substitute (20), is then combined (step 110) with the fat material (10). In one embodiment, as described above, gums can be added to the inulin solution before the inulin solution is combined with the fat material.

Next, an egg mixture (30) is combined (step 120) to the fat and sugar substitutes mixture to set up the dough for protein bonding. The egg mixture (30) typically includes whole or rehydrated eggs and/or egg whites, vanilla, salt and other flavorings. According to need, the egg mixture (30) may also include a colorant, an emulsifier and calcium caseinate. High intensity sweeteners may also be included in the egg mixture (30). The egg mixture (30) is typically prepared in a separate container, and its ingredients combined until the egg mixture (30) is smooth. After the egg mixture (30) is prepared, it is then combined (step 120) with the fat and sugar substitute blend. The eggs contain protein and appear to enhance the protein bonding/emulsification procedure. While the eggs can be eliminated from the cookie, the protein bonding/emulsification is much more delicate.

The protein material (40), which is combined (step 130) with the overall mixture after the addition of the egg mixture (30), is usually combined with the mixture by adding and blending whey proteins first, then adding and blending wheat proteins, and then adding and blending soy proteins. Because of the proteins' densities, isoelectric charges and bonding characteristics, this sequence of adding proteins allows the proteins to enter into and remain in a stable, bonded protein suspension. The proteins are blended in on slow speed to ensure thorough mixing without degrading their bonding in the suspension. Blending the proteins on high speed may increase the stickiness of the dough and degrade the bonding of the proteins, thereby degrading the texture and protein distribution of the cookie.

After the protein material (40) has been combined (step 130), the bulking agent (50) and leavening agent (60) can be combined to the mixture (step 140), either simultaneously or separately. Water may also need to be added after adding the protein material to rehydrate the cookie dough (80) if the dough (80) becomes too dry. In one embodiment, as shown in FIG. 2, flavor pieces (70) may be added (step 150) after the bulking agent and leavening agent have been combined (step 140). The resulting cookie dough (80) is then formed and shaped (step 160) according to the desired cookie shapes, and then baked (step 170) to create the completed cookie (100).

The cookie dough (80) is usually formed and shaped (step 160) into individual cookies as part of a larger cookie production system, as shown in FIG. 3. In the cookie production system (210), the cookie dough (80) is made by combining the ingredients in a mixer (220) as described above. The resulting dough (80) is then formed and shaped by a cookie cutter (230) and placed onto a baking surface (240), such as a sheet pan, a solid steel baking band, or a wire mesh baking band. The shaped dough (90) then passes into an oven (250) where it is baked into the completed cookies (100).

The cookie cutter (230) used in the system (210) is typically a wire cutter or rotary die cutter, depending on the consistency, viscosity and malleability of the cookie dough. Wire cut cookies are made by extruding the dough through openings in the wire cutter, and then cutting the dough by wires to achieve the desired weight and size for each cookie. Rotary die cookies are formed by passing the cookie dough through a rotary die, which presses the cookie dough into particular shapes and sizes. In smaller applications, the cookies can be formed and shaped manually rather than as part of a large cookie production system. Any means known to those of skill in the art can be used to form and shape the cookies, such as using cookie scoopers or cookie cutters.

In one embodiment, the oven (250) in which the shaped cookie dough (90) is baked is a traveling band oven. In another embodiment the oven (250) is a conventional or convection oven. Both the traveling band oven and a conventional oven typically bake the cookies at a temperature ranging from about 300° F. to about 500° F. Preferably, the traveling band oven temperature ranges from about 375° F. to about 470° F., and more preferably from about 400° F. to about 470° F. In one aspect the traveling band oven has a plurality of different zones, each zone having a progressively lower temperature. The shaped dough (90) is generally baked until the cookies (100) reach the desired texture and consistency. In one aspect, higher protein cookies are baked at lower temperatures around 300° F. Generally, the baking time for the dough (90) ranges from about 3 minutes to about 12 minutes. The resulting cookies (100) can then be used in many different forms and applications. For example, the cookies (100) can be used with a protein enhanced, low carbohydrate cookie frosting, in cream-filling cookie sandwiches, in ice cream sandwiches, as plain cookies, as shortbread cookies, etc. Generally, the protein enhanced, low carbohydrate cookie may be used in any application in which a traditional cookie is used.

By using a protein enhanced, low carbohydrate cookie frosting with the cookie, a sweet flavor and creamy texture is added to the cookie. In one aspect the frosting comprises a fat material, protein material, a sugar alcohol and flavoring. Any of the above-described ingredients may be used for these components. The frosting may also include an emulsifier, salt, a high intensity sweetener, and an edible acid, such as citric acid. Generally, the frosting comprises from about 40% to about 50% fat material, from about 38% to about 48% sugar substitute, from about 4% to about 14% protein material, and up to about 5% the remaining components. The frosting can be made by combining all components in a mixer and blending until the mixture becomes smooth. The frosting is then coated on the top surface of a shaped cookie dough, and then baked with the dough in an oven, as described above.

In another aspect, the cookie is used in conjunction with a protein enhanced, low carbohydrate cream filling, such as that described in U.S. patent application Ser. No. 10/839,330, filed May 4, 2004 by James C. Schmidt, the contents of which are incorporated herein by reference in their entirety. In one exemplary embodiment, this cream filling comprises from about 26% to about 44% fat material, from about 8% to about 22% sugar substitute, from about 5% to about 38% protein material, from about 21% to about 29% bulking agent, and up to about 12% flavoring. In another exemplary embodiment, the cream filling comprises about 29% fat material, about 49% sugar substitute, about 10% protein material, and about 11% water. The cream filling may also comprise other components as necessary and/or desired, such as flavoring or an emulsifier. Nevertheless, the cream filling to be used in conjunction with the cookie is not limited to the cream filling described above, but may be any low carbohydrate cream filling. The cookie using a cream filling can be made by depositing a layer of cream filling between two cookies. In another aspect, a cream filling may be wholly, or substantially wholly, enclosed by the cookie.

In accordance with the ingredients and principles described herein, a healthy and nutritional snack food can be made for consumption by those on a low carbohydrate diet, by those with diabetes, or just to satisfy the common “sweet tooth.” Whereas typical sugar-free cookies eliminate sugar carbohydrates but add other types of carbohydrates, such as oat bran, the cookies described herein eliminate substantially all net effective carbohydrates without adding to the total carbohydrate content. In addition, the cookies described herein may be packed with protein, vitamins and/or minerals, thereby providing an alternate means for supplying protein and other nutritional elements. Thus, the cookie performs the additional function of addressing dietary problems for those, especially children, who enjoy sweets but do not consume sufficient vitamins, minerals, and proteins due to the lack of flavor or appeal of other foods.

The principles, products and methods herein described can be better understood with a description of the following examples. It should be understood that the following are only examples and should not be used to limit the products and methods herein described to the methods and products described in the examples.

### EXAMPLE 1

A protein enhanced, low carbohydrate chocolate chip cookie was made from a cookie dough having the composition shown in Table 1, and in the manner described below.

TABLE 1

| Ingredient | Amount (ounces) |
|---|---|
| Butter | 16 |
| Crystalline Maltitol 300 | 10 |
| Sucralose | 0.2 |
| Eggs (powdered) | 1.3 |
| Water | 5 |
| Vanilla Extract (pure) | 2 |
| Caramel Color | 0.7 |
| Flour Salt | 0.2 |
| Lecithin | 0.1 |
| Whey Protein | 2 |
| Wheat Protein | 4 |
| Bamboo Fiber | 5 |
| Baking Soda | 0.2 |
| Sugarfree Chocolate Chips | 24 |

The cookie was made by first preparing a dough by performing the following steps. First, butter was combined with crystalline maltitol and sucralose in a mixer. This mixture was blended for about 5 minutes until it became smooth. Next, the egg mixture was prepared by combining in a separate container powdered eggs, water, pure vanilla extract, caramel color, flour salt and lecithin. Once combined, this egg mixture was added to the overall mixture and blended in for about 3 minutes on fast speed until the mixture became smooth. Whey protein was then added to the mixture and blended in on slow speed for about two minutes. After the mixture became smooth, wheat protein was then added and blended for about 2 minutes on slow speed, again until the mixture became smooth. Next, bamboo fiber, water and hydrated baking soda were added to the mixer and blended in on slow speed for about 3 minutes until the mixture became a smooth dough. In this dough, the water was added in 2 stages, first with the eggs and then a little at the last step with the fiber to achieve the best moist texture. Finally, sugarfree chocolate chips were then combined and blended with the resulting dough for about 1 minute on slow speed.

The dough was then formed into cookie shapes by passing the dough through a rotary die cutter. After the cookies had been formed and shaped, the cookies were baked in a traveling band oven having four different zones set to temperatures of 470° F., 450° F., 430° F. and 400° F. The cookies were baked in the oven for about 4 minutes.

### EXAMPLE 2

A protein enhanced, low carbohydrate chocolate sandwich cookie was made from a cookie dough having the composition shown in Table 2, and as described below.

TABLE 2

| | Amount | Ingredient |
|---|---|---|
| Ingredient | (lbs) | Temperature (° F.) |
| Butter | 110 | 63.0 |
| Maltitol FD-300 | 47.5 | 73.0 |
| Isomalt | 47.5 | 65.5 |
| Sucralose | 0.2 | 72.5 |
| Eggs (powdered) | 15 | 70.0 |
| Water | 30 | 48.0 |
| Vanilla Extract (pure) | 2 | 67.0 |
| Flour Salt | 1 | 71.0 |
| Lecithin | 1.5 | 67.0 |
| Chocolate Liquor | 7 | 113.0 |
| Cocoa Natural | 26 | 73.0 |
| Cocoa Jet Black | 18 | 73.0 |
| Whey Protein | 10 | 73.0 |
| Wheat Protein | 50 | 71.0 |
| Flour (unbleached) | 60 | 69.0 |
| Baking Soda | 1 | 71.0 |

The cookie was made by first preparing the dough, then forming and baking it into a cookie. To make the dough, butter was first combined with crystalline maltitol FD-300, isomalt and sucralose in a mixer. This mixture was blended for about 5 minutes until it became smooth. Next, the egg mixture was prepared by combining in a separate container powdered eggs, water, pure vanilla extract, flour salt and lecithin. Once combined, this egg mixture was added to the mixture and blended in for about 3 minutes on fast speed until the mixture became smooth. Next, the chocolate flavor components-chocolate liquor, cocoa natural, and cocoa jet black-were added and blended in to the mixture for about 2 minutes on fast speed until the mixture became smooth. The inside of the mixer bowl was then scraped to ensure all components were blended, after which the mixture was then blended for an additional 2 minutes on fast speed. Whey protein was then added to the mixture and blended in on slow speed for about two minutes. After the mixture became smooth, wheat protein was then added and blended for about 2 minutes on slow speed, again until the mixture became smooth. Next, unbleached flour and hydrated baking soda were added to the mixer and blended in on slow speed for about 3 minutes until the mixture became a smooth dough.

Next, the cookies were cut with a wire-cut cookie depositor to form individual cookies. These cookies were baked for about 4 minutes in a traveling band oven having four different zones set to temperatures of 470° F., 450° F., 430° F. and 400° F.

### EXAMPLE 3

A protein enhanced, low carbohydrate vanilla sandwich cookie was made from a cookie dough having the composition shown in Table 3, and as described below.

TABLE 3

| Ingredient | Amount (lbs) |
|---|---|
| Butter | 110 |
| Crystalline Maltitol MR-100 | 42 |
| Isomalt | 42 |
| Sucralose | 0.2 |
| Eggs (powdered) | 15 |
| Water | 25 |
| Vanilla Extract (pure) | 4 |
| Egg Shade Color | 0.32 |
| Flour Salt | 0.6 |
| Lecithin | 1.5 |
| Whey Protein | 10 |
| Wheat Protein | 60 |
| Flour (unbleached) | 95 |
| Baking Soda | 1 |

The cookie was made according to the method described above in Example 2, with two modifications. First, the egg mixture also included egg shade color. Second, the chocolate flavor components—chocolate liquor, cocoa natural and cocoa jet black—were not added in order to maintain the vanilla flavor.

### EXAMPLE 4

A protein enhanced, low carbohydrate chocolate sandwich cookie was made from a cookie dough having the composition shown in Table 4, and as described below.

TABLE 4

| | Amount | Ingredient |
|---|---|---|
| Ingredient | (lbs) | Temperature (° F.) |
| Butter (salted) | 110 | 73.5 |
| Maltitol FD-300 | 50 | 75.5 |
| Isomalt | 50 | 75.5 |
| Sucralose | 0.2 | 72.0 |
| Eggs (powdered) | 15 | 83.0 |
| Water | 28 | 54.5-55.0 |
| Vanilla Extract (pure) | 3 | 77.0 |
| Flour Salt | 1.5 | 80.5 |
| Lecithin | 1.5 | 79.0 |
| Cocoa Natural | 26 | 82.0 |
| Cocoa Jet Black | 18 | 80.5 |
| Whey Protein | 10 | 82.5 |
| Wheat Protein | 50 | 81.5 |
| Flour (unbleached) | 60 | 74.0 |
| Baking Soda | 1 | 79.5 |

The cookie was made according to the method described above in Example 2, with a few changes. First, the cookie eliminated the addition of chocolate liquor. Second, about 64% of the water was added with the egg mixture, and the remaining 36% was added with the baking soda to rehydrate the dough. The unbleached flour, water and baking soda were blended into the mixture for about 4 minutes instead of 3 minutes to ensure complete dispersion of the water in the dough.

### EXAMPLE 5

A protein enhanced, low carbohydrate shortbread-type cookie was made from a cookie dough having the composition shown in Table 5, and as described below.

TABLE 5

| | Amount |
|---|---|
| Ingredient | (lbs) |
| Butter | 157 |
| Crystalline Maltitol | 80 |
| Sucralose | 0.75 |
| Eggs (powdered) | 22 |
| Water | 50 |
| Vanilla Extract (pure) | 1.75 |
| Salt | 0.75 |
| Lecithin | 2.25 |
| Cocoa Natural | 59 |
| Whey | 39 |
| Gluten - arise | 78 |
| Soy | 34.2 |
| Baking Powder | 1 |

The cookie was made by preparing a dough and then baking the dough into cookies. The dough was prepared by first combining butter with crystalline maltitol and sucralose in a mixer. This mixture was blended for about 5 minutes on fast speed until it became smooth. Next, the egg mixture was prepared by combining in a separate container powdered eggs, water, pure vanilla extract, salt and lecithin. Once combined, this egg mixture was added to the mixture and blended in for about 3 minutes on fast speed until the mixture became smooth. Cocoa natural was then added to the mixture and blended for about 2 minutes on fast speed until the mixture became smooth. The inside of the mixer bowl was then scraped to blend in any cocoa powder stuck to the sides that the mixer could not reach, after which the mixture was blended an additional 2 minutes on fast speed. Whey protein was then added to the mixture and blended in on slow speed for about two minutes. After the mixture became smooth, wheat protein was then added and blended for about 2 minutes on slow speed, again until the mixture became smooth. Soy protein and baking powder were then added and blended in on slow speed for about 2 minutes until the mixture became smooth. The cookies were then baked at about 350° F. for about 3.8 minutes.

### EXAMPLE 6

A protein enhanced, low carbohydrate shortbread-type cookie was made from a cookie dough having the composition shown in Table 6, and as described below.

TABLE 6

| | Amount |
|---|---|
| Ingredient | (lbs) |
| Butter | 120 |
| Crystalline Maltitol | 40 |
| Isomalt | 40 |
| Sucralose | 0.6 |
| Eggs (powdered) | 22 |
| Water | 27 |
| Vanilla Extract (pure) | 2.6 |
| Salt | 0.75 |
| Lecithin | 2.25 |
| Whey | 9.75 |
| Gluten - arise | 69 |
| Soy | 9 |
| Baking Powder | 1 |
| Flour | 124 |

The cookie was made by preparing a dough and then baking the dough into cookies. The dough was prepared by first combining butter with crystalline maltitol, isomalt and sucralose in a mixer. This mixture was blended for about 5 minutes on fast speed until it became smooth. Next, the egg mixture was prepared by combining in a separate container powdered eggs, water, pure vanilla extract, salt and lecithin. Once combined, this egg mixture was added to the mixture and blended in for about 3 minutes on fast speed until the mixture became smooth. Whey protein was then added to the mixture and blended in on slow speed for about two minutes. After the mixture became smooth, wheat protein was then added and blended for about 2 minutes on slow speed, again until the mixture became smooth. Soy protein and baking powder were then added and blended in on slow speed for about 2 minutes until the mixture became smooth. Finally, flour was added and blended in on medium speed until the mixture became smooth. The cookies were then baked at about 350° F. for about 3.8 minutes.

### EXAMPLE 7

A protein enhanced, low carbohydrate shortbread-type cookie was made from a cookie dough having the composition shown in Table 7, and as described below

TABLE 7

| | Amount |
|---|---|
| Ingredient | (ounces) |
| Butter | 5 |
| Crystalline Maltitol | 3.5 |
| Sucralose | scant |
| Eggs | 2.1 (1 whole) |
| Vanilla Extract (pure) | ˜0.1 (¼ tsp) |
| Salt | ˜0.1 (pinch) |
| Cocoa | 1.5 |
| Whey | 2 |
| Gluten - arise | 1 |
| Soy | 1 |
| Baking Powder | ˜0.1 (¼ tsp) |

The cookie was prepared according to the method of Example 5, except that a whole egg was used in place of rehydrated powdered eggs. Thus, the cookie did not require the addition of water or lecithin.

### EXAMPLE 8

A protein enhanced, low carbohydrate cookie dough was made having the composition shown in Table 8, and as described below.

TABLE 8

| | Amount |
|---|---|
| Ingredient | (grams) |
| Butter | 19 |
| Crystalline Maltitol | 25 |
| Water | 10 |
| Eggs (powdered) | 12 |
| Vanilla Extract (pure) | 0.1 |
| Salt | 0.49 |
| Cocoa Natural | 8 |
| Whey Protein | 10 |
| Gluten - arise | 10 |
| Soy Protein | 10 |
| Baking Soda | 0.29 |
| Baking Powder | 0.29 |

The cookie dough was prepared by first combining butter with a sweetener solution containing crystalline maltitol and water. After this mixture was blended together, dry eggs, vanilla and salt were combined to the mixture and blended in. Next, cocoa natural was added and blended into the mixture. Whey protein was then added and blended in on slow speed until the mixture became smooth, after which wheat protein was added and blended in on slow speed, again until the mixture became smooth. Soy protein was added and blended in, after which baking powder and baking soda were then added and blended in to complete the dough.

### EXAMPLE 9

A protein enhanced, low carbohydrate chocolate sandwich cookie was made from a cookie dough having the composition shown in Table 9, and as described below.

TABLE 9

| | Amount |
|---|---|
| Ingredient | (ounces) |
| Butter | 8 |
| Crystalline Maltitol | 4 |
| Sucralose | Scant |
| Eggs | 2.1 (1 whole) |
| Vanilla Extract (pure) | ˜0.1 (¼ tsp) |
| Salt | ˜0.1 (pinch) |
| Cocoa Natural | 2 |
| Whey Protein | 1.5 |
| Gluten - arise | 1 |
| Soy Protein | 2.25 |
| Baking Powder | ˜0.1 (¼ tsp) |

The cookie was prepared according the method of Example 7, with the addition that baking soda was also added with the baking powder.

### EXAMPLE 10 (Frosting)

A protein enhanced, low carbohydrate cookie frosting was made from the composition shown in Table 10, and as described below.

TABLE 10

| | Amount | Ingredient |
|---|---|---|
| Ingredient | (lbs) | Temperature (° F.) |
| Palm Shortening | 158.5 | 77 |
| Lecithin | 1 | 75 |
| Vanilla Flavor | 7.5 | 68 |
| Flour Salt | 1 | 73 |
| Sucralose | 0.2 | 72 |
| Crystalline Maltitol MR-100 | 150 | 72 |
| Whey Protein | 30 | 76 |
| Citric Acid | 0.125 | 73 |

The frosting was prepared by first heating the palm shortening to a temperature of about 77° F. The palm shortening and other components were then combined in a mixer and blended together for about 7 minutes on fast speed. The mixture was then blended another 7 minutes to break up lumps created by the crystalline maltitol.

It is to be understood that the above-described arrangements are only illustrative of the application of the principles described herein. Modifications and alterations of may be devised by those skilled in the art without departing from the spirit and scope of the products and methods described herein, and the appended claims are intended to cover such modifications and arrangements.

1. A high protein, low carbohydrate cookie, comprising:
from about 10% to about 50% fat material;
from about 5% to about 40% sugar substitute; and
from about 5% to about 50% protein material.

2. The cookie of claim 1, further comprising
from about 5% to about 20% eggs;
up to about 50% bulking agent; and
up to about 25% flavoring.

3. The cookie of claim 1, further comprising water.

4. The cookie of claim 1, further comprising an emulsifier.

5. The cookie of claim 1, further comprising a leavening agent.

6. The cookie of claim 1, further comprising a colorant, flavor pieces, or a combination thereof.

7. The cookie of claim 1, further comprising vitamins, minerals, botanicals or a combination thereof.

8. The cookie of claim 1, further comprising a protein enhanced, low carbohydrate cookie frosting, the frosting comprising:
from about 40% to about 50% fat material;
from about 38% to about 48% sugar substitute; and
from about 4% to about 14% protein material.

9. The cookie of claim 8, wherein said frosting comprises:
about 45% fat material;
about 43% sugar substitute; and
about 9% protein material.

10. The cookie of claim 1, wherein said fat material comprises from about 18% to about 40%.

11. The cookie of claim 10, wherein said fat material comprises from about 25% to about 38%.

12. The cookie of claim 1, wherein said sugar substitute comprises from about 8% to about 36%.

13. The cookie of claim 12, wherein said sugar substitute comprises from about 15% to about 24%.

14. The cookie of claim 1, wherein said protein material comprises from about 7% to about 38%.

15. The cookie of claim 14, wherein said protein material comprises from about 12% to about 30%.

16. The cookie of claim 1, wherein said bulking agent comprises up to about 40%.

17. The cookie of claim 16, wherein said bulking agent comprises up to about 30%.

18. The cookie of claim 1, wherein said fat material comprises butter.

19. The cookie of claim 1, wherein said sugar substitute comprises a sugar alcohol.

20. The cookie of claim 19, wherein said sugar substitute further comprises a high intensity sweetener.

21. The cookie of claim 1, wherein said sugar substitute comprises inulin.

22. The cookie of claim 21, wherein said sugar substitute further comprises a gum.

23. The cookie of claim 1, wherein said bulking agent comprises fiber.

24. The cookie of claim 1, wherein said bulking agent comprises starch.

25. The cookie of claim 1, wherein said protein material comprises whey protein.

26. The cookie of claim 1, wherein said protein material comprises wheat protein.

27. The cookie of claim 1, wherein said protein material comprises soy protein.

28. A high protein, low carbohydrate cookie, comprising:
butter;
crystalline maltitol;
whey protein;
wheat protein; and
eggs.

29. The cookie of claim 28, comprising from about 2% to about 20% whey protein.

30. The cookie of claim 28, comprising from about 2% to about 15% whey protein.

31. The cookie of claim 28, comprising from about 4% to about 20% wheat protein.

32. The cookie of claim 28, comprising from about 4% to about 15% wheat protein.

33. The cookie of claim 28, further comprising soy protein.

34. The cookie of claim 33, wherein said soy protein comprises up to about 15% of said cookie.

35. The cookie of claim 33, wherein said soy protein comprises up to about 11% of said cookie.

36. The cookie of claim 28, further comprising fiber.

37. The cookie of claim 36, wherein said fiber comprises up to about 40% of said cookie.

38. The cookie of claim 36, wherein said fiber comprises from about 7% to about 37% fiber.

39. The cookie of claim 28, further comprising flavor pieces.

40. The cookie of claim 28, further comprising a combination of at least two of the following:
water;
flour;
isomalt;
high intensity sweetener;
vanilla extract;
salt;
lecithin;
a casein;
chocolate liquor;
cocoa natural;
cocoa jet black; and
leavening agent.

41. A method for making a high protein, low carbohydrate cookie, comprising making a cookie dough by combining fat material, a sugar substitute and protein material, wherein said protein material is combined after said fat material and sugar substitute are combined.

42. The method of claim 41, wherein said protein material comprises whey protein, wheat protein, soy protein, or a combination thereof, and wherein the sequence for combining said protein material is first whey protein, then wheat protein, then soy protein.

43. The method of claim 41, further comprising combining an egg mixture before combining said protein material, wherein said egg mixture comprises eggs, salt and flavoring.

44. The method of claim 43, further comprising water, coloring, an emulsifier or a combination thereof.

45. The method of claim 41, further comprising combining a bulking agent, a leavener, or a combination thereof, after combining said protein material.

46. The method of claim 41, further comprising combining flavoring before combining said protein material.

47. The method of claim 46, wherein said flavoring comprises chocolate liquor, cocoa, or a combination thereof.

48. The method of claim 41, wherein said cookie dough is baked in an oven for about 3 to about 12 minutes, and wherein the oven temperature ranges from about 350° F. to about 500° F.

49. The method of claim 48, wherein said oven temperature ranges from about 375° F. to about 470° F.

50. The method of claim 48, wherein said oven temperature ranges from about 400° F. to about 470° F.

51. A method for making a high protein, low carbohydrate cookie, comprising:
combining butter and crystalline maltitol;
adding an egg mixture;
adding whey protein;
adding wheat protein; and
adding fiber or starch.

52. A method for supplying fiber in a diet, comprising eating a protein enhanced, low carbohydrate snack food, the snack food comprising:
from about 10% to about 50% fat material;
from about 5% to about 40% sugar substitute; and
from about 5% to about 50% protein material.

53. A method for supplying protein in a diet, comprising eating a protein enhanced snack food, the snack food comprising:
from about 10% to about 50% fat material;
from about 5% to about 40% sugar substitute; and
from about 5% to about 50% protein material.

54. A diet for diabetics, comprising a snack food comprising:
from about 10% to about 50% fat material;
from about 5% to about 40% sugar substitute;
from about 5% to about 50% protein material.

55. A system for making a protein enhanced, low carbohydrate snack food, comprising:
a protein enhanced, low carbohydrate cookie dough;
a cookie cutter, wherein the cookie cutter is a wire cutter or a rotary die cutter; and
an oven.

56. A snack food, comprising two outer layers and a middle layer, the two outer layers each comprising a protein enhanced, low carbohydrate cookie, and the middle layer comprising a protein enhanced, low carbohydrate cream filling, the cream filling comprising:
from about 26% to about 44% fat material;
from about 8% to about 22% sugar substitute;
from about 5% to about 38% protein material.

57. The snack food of claim 56, wherein said cream filling is substantially enclosed by said outer layers.

58. The snack food of claim 56, wherein said middle layer comprises ice cream.
